(19) United States
(12) Patent Application Publication
(10) Pub. No.: US 2016/0109337 A1
(43) Pub. Date: Apr. 21, 2016

(54) METHOD AND SYSTEM FOR INDICATING TIME ON A REAGENT CONTAINER

(71) Applicant: Sakura Finetek U.S.A., Inc., Torrance, CA (US)

(72) Inventors: Wouter Valkenier, Utrecht (NL); Robert Heijmen, Eemnes (NL); Ralf van den Berg, The Hague (NL)

(21) Appl. No.: 14/518,793

(22) Filed: Oct. 20, 2014

(51) Int. Cl. G01N 1/30; G01N 1/31

(52) U.S. Cl. CPC G01N 1/30; G01N 1/31

(57) ABSTRACT

An apparatus, system and method for monitoring fixation of a biological sample within a container. The apparatus system or method including a container having a fixation medium for fixation of a biological sample placed within the container and a label attached to the container, the label having a time indicator operable to automatically indicate a processing time of a biological sample placed within the fixation medium.

### BACKGROUND

1. Field

A method and system for indicating time on a reagent container, in particular, a method and system for indicating fixation time of a biological sample exposed to a fixation medium in a reagent container.

2. Background

In various settings, processing and testing of biological specimens is required for diagnostic purposes. Generally speaking, pathologists and other diagnosticians collect and study samples from patients, and utilize microscopic examination, and other devices to assess the samples at cellular levels. Numerous steps typically are involved in pathology and other diagnostic processes, including the collection of biological samples such as blood and tissue, processing the samples, preparation of microscope slides, staining, examination, re-testing or re-staining, collecting additional samples, re-examination of the samples, and ultimately the offering of diagnostic findings.

The collection of biological samples is typically performed by a healthcare provider (e.g. a laboratory technician) at a hospital or clinic. In particular, the provider collects the sample (e.g. blood or tissue) from the patient and then places the sample in a leak tight container. The container is then transported to a laboratory for processing. To prevent tissue deterioration during transport of the sample to a laboratory, the container is pre-filled with a fixative. To get the most optimal end-result, the sample should be fixated prior to the laboratory process. The time it takes to fixate the sample may depend, for example, upon the type of sample, dimensions and temperature. Typically, the fixation start time is determined by a technician and written on a container label at the time of collection and then the laboratory, upon receipt of the container, reviews the fixation start time to determine if the sample is fixed and ready for processing. Such a system, however, can lead to errors because it relies heavily on the accuracy of the technician. For example, the technician may incorrectly print the start time on the container, illegibly print the start time and/or the receiving technician may incorrectly determine the fixation time based on the start time.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates a perspective view of one embodiment of a reagent container having a fixation indicator.

FIG. 2A illustrates a front plan view of one embodiment of a fixation indicator.

FIG. 2B illustrates a side cross-sectional view of the fixation indicator of FIG. 2A along line B-B′.

FIG. 3 illustrates a front plan view of another embodiment of a fixation indicator.

FIG. 4 illustrates a front plan view of another embodiment of a fixation indicator.

FIG. 5 illustrates a flow chart of one embodiment of a process for monitoring fixation of a biological sample.

FIG. 6 illustrates a flow chart of another embodiment of a process for monitoring fixation of a biological sample.

FIG. 7 illustrates a flow chart of another embodiment of a process for monitoring fixation of a biological sample.

### DETAILED DESCRIPTION

In the following paragraphs, the present invention will be described in detail by way of example with reference to the accompanying drawings. Throughout this description, the preferred embodiments and examples shown should be considered as exemplars, rather than as limitations on the present invention. Furthermore, reference to various aspects of the embodiments disclosed herein does not mean that all claimed embodiments or methods must include the referenced aspects.

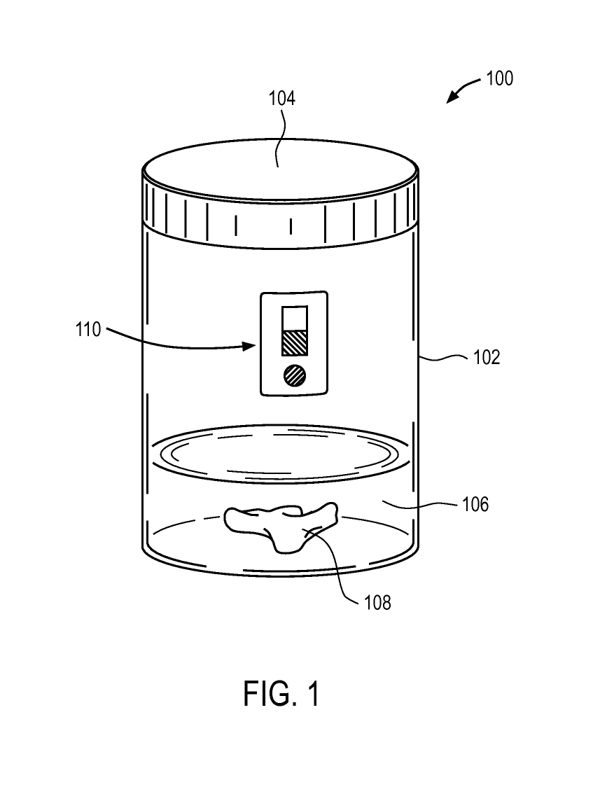

FIG. 1 illustrates a perspective view of one embodiment of a reagent container having a fixation indicator. Representatively, FIG. 1 illustrates fixation monitoring system 100 including a container 102 with a fixation indicator 110 attached thereto. Container 102 may include a lid 104 to secure its contents therein. In some embodiments, container 102 may be considered a reagent container in that it is designed to hold a substance such as a fixation medium 106 for processing of items placed within container 102. In one embodiment, the fixation medium 106 may be, for example, a chemical fixative such as a cross-linking fixative, a precipitating fixative or an oxidizing fixative. Representative cross-linking fixatives may include, but are not limited to, aldehydes such as formaldehyde or glutaraldehyde. Representative precipitating fixatives may include, but are not limited to, methanol, ethanol or acetone. Representative oxidizing fixatives may include, but are not limited to, osmium tetroxide, potassium dichromate, chromic acid or potassium permanganate. It is noted, however, that although the substance within container 102 is described as a fixation medium herein, other types of substances that could benefit from the processing and monitoring disclosed herein could be used within container 102 (e.g. stains).

During operation, a biological sample 108 is placed in container 102. In some embodiments, the fixation medium 106 may already be in container 102. Alternatively, the fixation medium 106 may be selected based on the type of biological sample 108 placed in an empty container 102, and then added to container 102. In the case where the fixation medium 106 is already in the container, the technician obtaining the biological sample 108 may select a container based upon the type of fixation medium already in the container. Once placed in container 102, the biological sample 108 is exposed to the fixation medium for a period of time sufficient for fixation to occur. The period of time may be different depending upon characteristics of the biological sample (e.g. type, size, density, etc.) as well as the type of fixation medium. It is important, however, that regardless of the period of time, the sample is completely fixated before the technician removes the biological sample for further processing. In other words, the biological sample can remain in the fixation medium after fixation without causing harm to the sample, but should not be taken out prior to fixation. In this aspect, it is important that the lab technician receiving the container 102 having biological sample 108 know the precise fixation time so that they don't have to wait extra time to ensure fixation, which in turn can unnecessarily delay further processing on the biological sample.

Container 102 therefore further includes a fixation indicator 110. Fixation indicator 110 provides an indication of a processing time or a fixation time of the biological sample 108 placed within fixation medium 106. The fixation time may be a period of time that is predetermined based on the type of biological sample and fixation medium within container 102. Representatively, fixation indicator 110 may indicate a period of time the biological sample 108 is exposed to fixation medium 106. In some embodiments, fixation indicator 110 may be configured to indicate a period of time equal to or less than a period of time required for fixation of the biological sample 108 within fixation medium 106. For example, where it is determined, based on the type of biological sample 108 and type of fixation medium 106 that it takes 24 hours for the fixation medium 106 to fix the biological sample 108, fixation indicator 110 may indicate a period of time of up to 24 hours. In this aspect, fixation indicator 110 is used to indicate to the technician receiving the container 102 with the biological sample 108 therein, whether the biological sample 108 has been in the fixation medium 106 long enough for fixation to be complete. Said another way, the fixation indicator 110 indicates whether the biological sample 108 has been in the fixation medium 106 for a period of time less than or equal to a predetermined period of time sufficient for completion of fixation. In other words, the processing time or the fixation time indicated by fixation indicator 110 can be directly tied to, and based on, the time it takes to fix a particular biological sample 108 within a particular fixation medium 106. This is in contrast to other time indicating systems which generally indicate whether, for example, an item such as a food product has expired or is no longer safe for human consumption or use. In addition, it should be understood that fixation indicator 110 may be adjusted to room temperature at, for example 22 degrees)(° C., but indicates time only. The time displayed by the fixation indicator 110 is therefore not associated with or affected by, for example, a temperature or any other conditions that may be associated with the sample, container, and/or fixation medium.

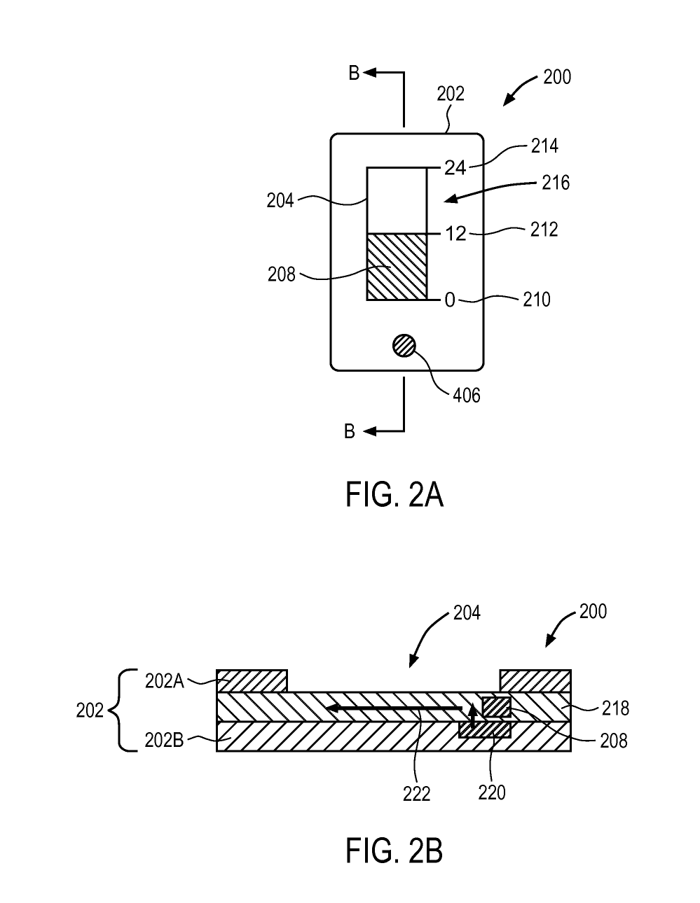

FIG. 2A illustrates a front plan view of one embodiment of a fixation indicator. Fixation indicator 200 may be similar in some respects to, for example, the time indicators manufactured by Timestrip® of the United Kingdom. Fixation indicator 200 may be considered a passive indicator in that it does not require any electronic components or circuitry to drive its operation. Representatively, fixation indicator 200 may include a support member 202 and a display 204. Support member 202 may be, for example, in the form of a label which, in some embodiments, in addition to display 204, can contain printed information about the container on which it is placed. In addition, support member 202 may have an adhesive backing such that it can be adhered to a container. Within support member 202 there may be a migration medium 208 which, upon activation of fixation indicator 200, migrates within support member 202 and is visible through display 204. The migration medium 208 may be visible based on its color, or a color change that occurs within display 204 as migration medium 208 migrates across the display 204.

Display 204 may be formed by, for example, a window and/or transparent material within support member 202. A time scale 216 may be provided along a side of display 204. The time scale 216 may include numbers 210, 212, 214 which correspond to a predetermined period of time required for fixation of a biological sample. The migration medium 208 is specially designed to migrate through support member 202 at a rate which corresponds to the desired time scale such that the user can determine, based on the migration of the migration medium 208, a period of time the biological sample has been exposed to the fixation medium and, ultimately, whether the biological sample is fixated. For example, where it is determined that it takes 24 hours for a particular sample to be fixated within a fixation medium, time scale 216 may include time zero 210, time twelve 212 and time twenty-four 214, which correspond to hour increments. Once the biological sample is placed in the container upon which indicator 200 is attached and exposed to the fixation medium, the actuator 206 is pressed to activate the indicator. Once activated, the migration medium 208 starts to migrate through support member 202 and its progress is viewed through display 204. When the level of the migration medium 208 reaches time twelve 212, the user will understand that the biological sample has been exposed to the fixation medium for 12 hours. When the level of the migration medium 208 reaches time twenty-four 214, the user will understand that the biological sample has been exposed to the fixation medium for 24 hours. In embodiments, where the period of time required for fixation is twenty-four hours, the user will understand based on indicator 200 that the biological sample is fixed and ready to be removed from the container for the next processing step. Although time increments of zero, twelve and twenty-four hours are described in FIG. 2A, it is contemplated that any time increment depending upon the predetermined fixation time may be used in the time scale 216. For example, in other embodiments, the fixation time may be from about 4 hours to about 24 hours, for example, from about 6 hours to about 20 hours, for example, from about 8 hours to 15 hours, thus time increments reflecting these further time periods may be used for time scale 216.

The operation of fixation indicator 200 may be better understood in reference to FIG. 2B. FIG. 2B illustrates a side cross-sectional view of the fixation indicator of FIG. 2A along line B-B′. Representatively, from this view, it can be seen that support member 202 includes a top layer 202A and bottom layer 202B. Layers 202A-202B may be, for example, layers of plastic material that are attached together. In some cases, one or more of layers 202A-202B may include an adhesive surface to facilitate attachment of the layers to each other and/or a surface (e.g., a surface of container 102). Between layers 202A-202B is a migration layer 218 through which the migration medium 208 migrates. In this aspect, the migration layer 218 may be made of a porous material through which the migration medium 208 can pass. Prior to activation of fixation indicator 200, the migration medium 208 may be held within a pocket 220 which is separate from migration layer 218. Upon activation, the migration medium 208 comes into contact with migration layer 218 and begins to migrate through layer 218 in the direction of arrows 222. The migration of migration medium 208 is viewed through display 204 and used to provide an indication of processing time or fixation time as previously discussed. Migration medium 208 may be any type of liquid/dye combination capable of migrating through a migration layer in the desired period of time and being visible by a user. Representatively, the migration medium 208 may be any liquid substance such as an oil/dye combination, a water/dye combination, or a gel/dye combination. Other additives may also be included in the liquid substance to modify the viscosity to achieve the desired rate of migration.

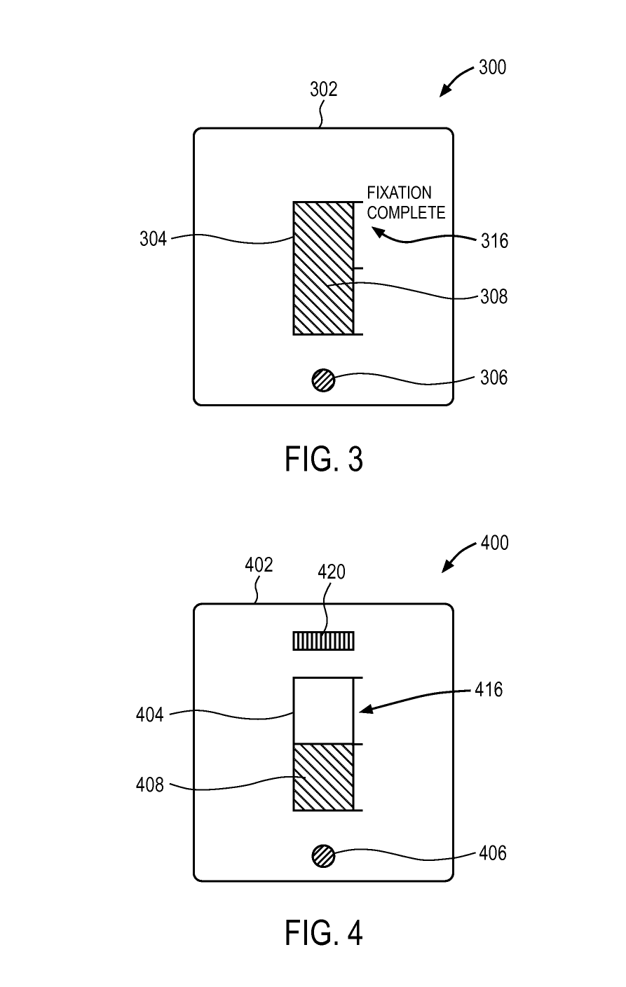

FIG. 3 illustrates a front plan view of another embodiment of a fixation indicator. Fixation indicator 300 is substantially similar to fixation indicator 200 described in reference to FIGS. 2A-2B, in that indicator 300 includes support member 302 (e.g. a label), display 304, migration medium 308 and actuator 306. In this embodiment, however, the time scale 316 is not provided in time increments, rather a single marker 316, which indicates when fixation is complete. Representatively, single marker 316 may be the phrase “Fixation Complete” printed on support member 302 at the top end of display 304. Single marker 316 may correspond to a period of time in which fixation is complete. In this aspect, once the fixation medium 308 reaches indicator 316 the technician knows fixation is complete. If fixation medium 308 is not yet at single marker 316, the technician knows they must leave the biological sample in the fixation medium for additional time.

FIG. 4 illustrates a front plan view of another embodiment of a fixation indicator. Fixation indicator 400 is substantially similar to fixation indicator 200 described in reference to FIGS. 2A-2B, in that indicator 400 includes support member 402 (e.g. a label), display 404, actuator 306, migration medium 408 and time scale 416. In this embodiment, however, fixation indicator 400 further includes an identifier 420. Identifier 420 may provide additional sample processing information. For example, identifier 420 may identify the patient associated with the sample being fixed. In other embodiments, identifier 420 may identify the fixation medium and/or the fixation time required to fix a sample exposed to the fixation medium. In still further embodiments, identifier 420 may provide information on other processing steps to be performed in connection with the sample upon fixation. In still further embodiments, identifier 420 may indicate sample specific information, for example, the maximum dimensions of the tissue sample to be fixed within the container.

In some embodiments, identifier 420 may be a machine readable identifier. For example, identifier 420 may be a radio frequency identification (RFID) tag that can be read by a scanner or other type of reading device. It is further contemplated that identifier 420 may include optically readable data such as 1-D data, such as that found in a bar code, or 2-D data such as that which can be read optically by an optical reader (e.g. a CCD camera). In some embodiments, information obtained from identifier 420 may be used for automated identification and registration of the biological sample in a hospital or laboratory information system.

It should further be understood that an identifier or label such as identifier 420 could be attached to the container lid (e.g. lid 104) and contain any of the above-discussed types of information. For example, the identifier or label on the lid could provide sample processing information, patient information, fixation medium and/or time information, or sample specific information, for example, the maximum dimensions of the tissue sample to be fixed within the container.

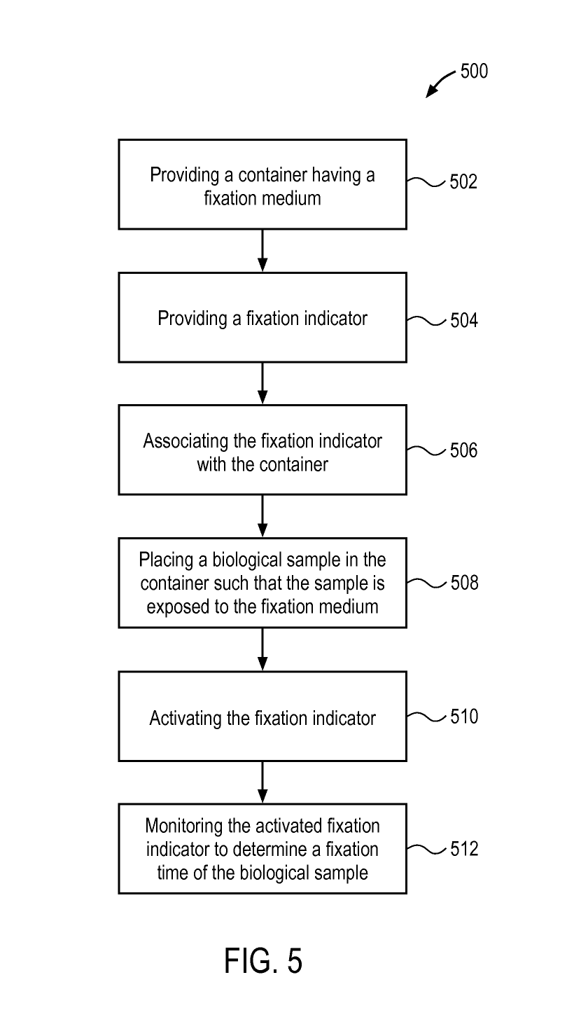

FIG. 5 illustrates a flow chart of one embodiment of a process for monitoring fixation of a biological sample. Representatively, process 500 includes providing a container having a fixation medium (block 502). The container and the fixation medium may be any of the previously discussed embodiments, for example, a reagent container having a lid and a fixation medium such as a cross-linking fixative, a precipitating fixative or an oxidizing fixative. A fixation indicator may further be provided (block 504). The fixation indicator may be any of the fixation indicators previously discussed in reference to FIGS. 2-4. In one embodiment, the fixation indicator may be selected and/or correspond to the type of fixation medium in the container. For example, where the fixation medium fixes a biological sample placed in 24 hours, the display of the fixation indicator may have a 24-hour time scale. Alternatively, where the fixation medium fixes the biological sample in 8 hours, the time scale on the fixation indicator may go up to only 8 hours, and/or include an 8-hour marker so that the user knows whether fixation is complete.

Process 500 further includes associating the fixation indicator with the container (block 506). Representatively, the fixation indicator may have an adhesive backing as previously discussed such that it can be adhered directly to a surface of the container, for example, a side, top (e.g. lid) or bottom.

Once the fixation indicator is attached to the container, a biological sample may be placed within the container such that it is exposed to the fixation medium (block 508). The biological sample may be any type of sample in which fixation is required for further processing. For example, the biological sample may be a sample of mammalian tissue, for example, human tissue or animal tissue. The biological sample may be obtained from the mammal (e.g. using a biopsy procedure) and then placed within the container such that it is submersed in the fixation medium.

One the biological sample is exposed to the fixation medium, the fixation indicator is activated (block 510). It is important that activation occur immediately so that the period the biological sample is exposed to the fixation medium can be accurately tracked and monitored. For example, in some embodiments, the fixation indicator is activated simultaneously with placing the biological sample in the fixation medium. Alternatively, it is activated shortly thereafter. Activation may occur, for example, by pressing an actuator on the fixation indicator which causes migration of a migration medium within the indicator to migrate across the display as previously discussed. In other embodiments, the fixation indicator may be activated upon closing of the container, for example, the fixation indicator may include an actuator along the lid of the container which is pressed by the container lid to activate it.

With the fixation indicator activated and the fixation process under way within the container, the container may be transported to the desired lab for further processing. The fixation process may be monitored by a technician (or an information management system) to determine a fixation time of the biological sample (block 512). For example, in one embodiment, upon receiving the container, the laboratory technician looks at the fixation indicator display. If the migration medium visible through the display has reached the desired time on the time scale (or the “Fixation Complete” mark), the technician determines that the biological sample is fixed and may be removed from the container at any time for further processing. If, on the other hand, the desired mark on the time scale is not reached, the technician can determined the period of time remaining to fixation and leave the sample in the container for the additional period of time. For example, if the technician knows it takes 24 hours for fixation of the sample to be complete but the display shows the sample has only been exposed to the fixation medium for 12 hours, the technician determines the sample must remain in the fixation medium for another 12 hours. The fixation indicator can then be checked at any point to determine its progress.

It is further to be understood that although the technician may manually check the indicator, the fixation process may also be automatically tracked by a software based management system, for example, a hospital information system (HIS) or a laboratory information system (LIS). For example, the information management system may, through the aid of a scanner, determine that the fixation indicator has been activated and then register this information in the system. Since the system knows the time when the indicator was activated (and in turn when the biological sample was exposed to the fixation medium), the system can then track the period of time to fixation. In some cases, the system may be designed to automatically alert the technician when fixation is complete, such as using an audible or visible alarm.

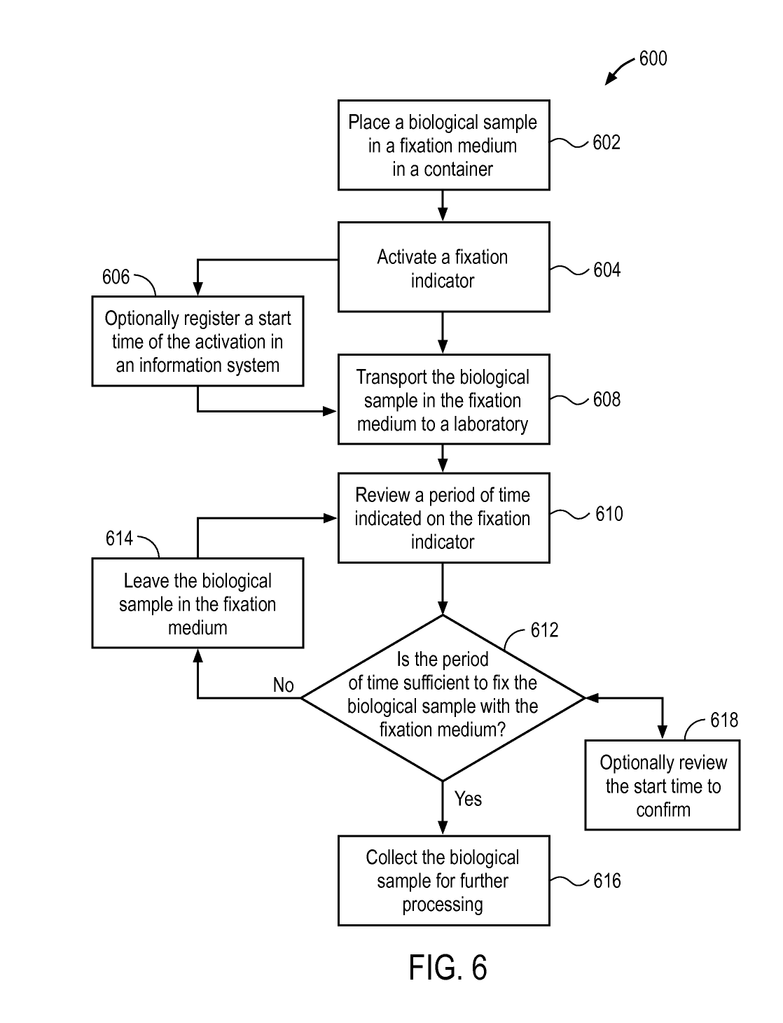

FIG. 6 illustrates a flow chart of another embodiment of a process for monitoring fixation of a biological sample. In process 600, the biological sample is placed in a fixation medium within a container (block 602). Upon exposing the sample to the fixation medium, the fixation indicator is activated as previously discussed (block 604). Optionally, a start time of the activation may be registered in HIS or LIS (block 606). This provides a further fixation tracking mechanism, but is not required. The container with the biological sample and fixation medium therein is then transported to a laboratory (block 608). Once received in the laboratory, the period of time indicated on the fixation indicator is reviewed (block 610). In some cases, the period of time is reviewed by the receiving technician, and may then be registered in the system (e.g. HIS or LIS). In other embodiments, the period of time may be automatically determined, such as by scanning the fixation indicator. Based on the period of time indicated by the fixation indicator, it is then determined whether the period of time is sufficient to fix the biological sample with the fixation medium (block 612). If the answer is “no”, the biological sample is left in the fixation medium for a longer period of time (block 614). If the answer is “yes”, the biological sample may be collected from the container for further processing (block 616). Optionally, the start time registered in the system may also be reviewed to confirm the fixation status (block 618).

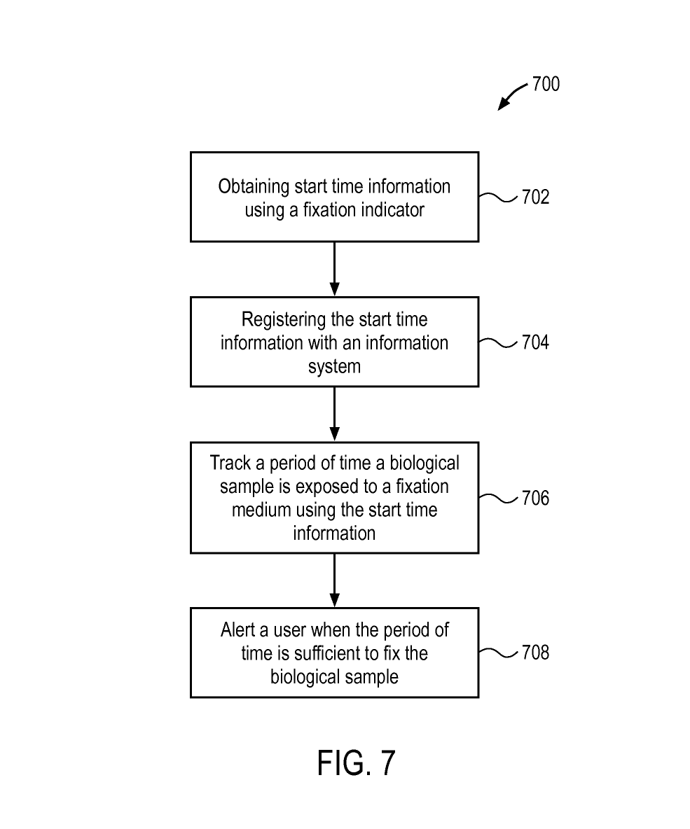

FIG. 7 illustrates a flow chart of another embodiment of a process for monitoring fixation of a biological sample. Process 700 illustrates monitoring fixation of the biological sample using start time information. Representatively, the time at which the biological sample is exposed to the fixation medium may be obtained (block 702). For example, the technician may activate the fixation indicator and, at the same time, determine the corresponding time of activation. In some case, this start time may be displayed by the fixation indicator, such as by marking the start time on the indicator or entering the start time information into a barcode on the indicator. This start time may then be registered with a software based management system, for example a HIS or LIS (block 704). Based on this start time, the management system may then track a period of time the biological sample has been exposed to the fixation medium (block 706). For example, the start time may be entered into the management system. The period of time it takes to fix the sample may also be entered into the system. Based on this information, the system may then display, for example, in second, minute, and/or hour increments, an upward count from zero to the desired end time (e.g. 24 hours) so that the technician knows precisely how much time has elapsed. Alternatively, the system may display a countdown from the end time to zero such that the technician knows precisely how much time is left to fixation. The management system may further include an alert system such that when a period of time sufficient to fix the biological sample is reached, the technician is automatically alerted (block 708). The alert may be an audible or visible alert on, for example, the laboratory computing device or other device the technician may be using to monitor the sample.

It should be understood that the algorithms and displays presented herein are not inherently related to any particular computer or other apparatus. Various general purpose systems may be used with programs in accordance with the teachings herein or it may prove convenient to construct a more specialized device to perform the described processes disclosed herein. In addition, the invention is not described with reference to any particular programming language. It will be appreciated that a variety of programming languages may be used to implement the teachings of the invention as described herein.

A computer readable medium, which may be used to implement any of the processes disclosed herein on, for example a software application or other software based computing system, includes any mechanism for storing information in a form readable by a computer. For example, a computer readable medium includes read only memory (“ROM”), random access memory (“RAM”), magnetic disk storage media, optical storage media, flash memory devices or other type of machine-accessible storage media.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

In the foregoing specification, the invention has been described with reference to specific embodiments thereof. It will, however, be evident that various modifications and changes can be made thereto without departing from the broader spirit and scope of the invention as set forth in the appended claims. For example, it should be understood that although information associated with the fixation indicator disclosed herein may be registered with an HIS or LIS, this is not required and therefore fixation time can be accurately monitored and determined independently and without such systems. In addition, although a fixation start time can optionally be determined and used by a technician to monitor sample fixation, it is not required therefore errors due to manual tracking of the fixation by the technician (such as by misprinting information) are eliminated. In this aspect, monitoring of sample fixation is more standardized. The specification and drawings are, accordingly, to be regarded in an illustrative rather than a restrictive sense.

What is claimed is:

1. A reagent container comprising:
a container having a fixation medium for fixation of a biological sample placed within the container; and
a label attached to the container, the label having a time indicator operable to automatically indicate a processing time of a biological sample placed within the fixation medium.

2. The reagent container of claim 1 wherein the time indicator comprises a liquid-migration medium operable to provide an indication of the processing time.

3. The reagent container of claim 1 wherein the processing time is a period of time the biological sample is exposed to the fixation medium.

4. The reagent container of claim 1 wherein the processing time is a period of time equal to or less than a period of time required for fixation of the biological sample within the fixation medium.

5. The reagent container of claim 1 wherein the processing time is 24 hours or less.

6. The reagent container of claim 1 wherein the indicator provides a numerical indicator of the processing time.

7. The reagent container of claim 1 wherein the indicator provides a color indicator of the processing time.

8. The reagent container of claim 1, the indicator further comprising:
information identifying a patient associated with the biological sample.

9. The reagent container of claim 1 wherein the fixation medium is a chemical fixative selected from the group consisting of a cross-linking fixative, a precipitating fixative or an oxidizing fixative.

10. A system for monitoring fixation of a biological sample within a container, the system comprising:
a container having a fixation medium for fixation of a biological sample placed within the container; and
a fixation indicator attached to the container, the fixation indicator operable to, upon activation, indicate a fixation time of a biological sample placed within the container.

11. The system of claim 10 wherein the fixation time is a period of time a biological sample within the container is exposed to the fixation medium.

12. The system of claim 10 wherein the fixation time is displayed as an amount of time that elapses while the biological sample is exposed to the fixation medium.

13. The system of claim 10 wherein the fixation time is predetermined based on the biological sample type and the fixation medium type.

14. The system of claim 10 wherein the fixation indicator indicates a start time, the start time being the time the biological sample is first exposed to the fixation medium.

15. A method for monitoring fixation of a biological sample within a container, the method comprising:
providing a container having a fixation medium for fixation of a biological sample placed within the container; and
providing a label on the container, the label having a fixation indicator operable to indicate a period of time a biological sample is exposed to a fixation medium within the container.

16. The method of claim 15 further comprising:
placing the biological sample in the container; and
activating the fixation indicator after placing the biological sample within the container.

17. The method of claim 15 further comprising:
obtaining start time information, the start time information identifying a time the biological sample is placed in the fixation medium; and
registering the start time information with an information management system to automatically track the period of time the biological sample is exposed to the fixation medium within the container.

18. The method of claim 17 further comprising:
alerting a user when the period of time the biological sample is exposed to the fixation medium is sufficient for fixation of the biological sample.

19. The method of claim 15 wherein the label further comprises a machine readable identifier.

20. The method of claim 19 wherein the machine readable identifier comprises biological sample associated information.

21. The method of claim 19 wherein the machine readable identifier comprises fixation medium associated information identifying the time required to fix the biological sample in the fixation medium.
